(19) United States
(12) Patent Application Publication
(10) Pub. No.: US 2019/0033772 A1
(43) Pub. Date: Jan. 31, 2019

(54) IMAGE FORMING APPARATUS AND IMAGE FORMING METHOD

(71) Applicant: Kunihiro Komai, Kanagawa (JP)

(72) Inventor: Kunihiro Komai, Kanagawa (JP)

(73) Assignee: Ricoh Company, Ltd., Tokyo (JP)

(21) Appl. No.: 16/031,211

(22) Filed: Jul. 10, 2018

(30) Foreign Application Priority Data
Jul. 26, 2017 (JP) 2017-144255

(51) Int. Cl. G03G 15/00; G06K 15/02; G06K 15/00; G03G 15/02

(52) U.S. Cl. CPC G03G 15/80; G03G 15/0266; G06K 15/406; G06K 15/1825

(57) ABSTRACT

An image forming apparatus includes at least one photoconductor unit including a charging roller and a photoconductor. A charging bias obtained by superimposing an AC voltage on a DC voltage is applied to the charging roller. The photoconductor is disposed opposite the charging roller across a gap. An electrostatic latent image is formed on the photoconductor based on image data. The image forming apparatus further includes a high-voltage power supply to generate an output feedback voltage, a control unit as circuitry to control the high-voltage power supply based on the output feedback voltage and refer to first data to calculate the gap value corresponding to the voltage indicated by the output feedback voltage. The first data indicates a relation between the voltage indicated by the output feedback voltage and a gap value indicating a size of the gap.

### CROSS-REFERENCE TO RELATED APPLICATION

This patent application is based on and claims priority pursuant to 35 U.S.C. § 119(a to Japanese Patent Application No. 2017-144255, filed on Jul. 26, 2017, in the Japan Patent Office, the entire disclosure of which is hereby incorporated by reference herein.

### BACKGROUND

### Technical Field

The present disclosure relates to an image forming apparatus and an image forming method.

### Related Art

In electrophotographic image forming apparatuses, a high-voltage charging bias is applied to a charging roller to uniformly charge a photoconductor, and then the photoconductor is exposed according to image signals, thereby forming electrostatic latent images on the photoconductor.

The charging bias is a direct current (DC) voltage or an alternating current (AC) voltage superimposed on the DC voltage. The charging bias obtained by superimposing the AC voltage on the DC voltage is preferable to uniformly charge the photoconductor.

If an optimum voltage corresponding to a gap between the photoconductor and the charging roller is not applied to the charging roller, defective images may result. For example, if the charging bias for charging the photoconductor is insufficient, defective images with black dots may occur. On the other hand, if the charging bias for charging the photoconductor is excessive, defective images with white spots may occur.

If peak-to-peak voltage Vpp of the AC voltage is excessive, an electric arc is generated from the charging roller to the photoconductor, thereby shortening the life of the photoconductor.

Therefore, there is a known technology that a sensor detects the size of the gap between the photoconductor and the charging roller to control the peak-to-peak voltage Vpp as appropriate.

### SUMMARY

According to embodiments of this disclosure, an improved image forming apparatus includes at least one photoconductor unit including a charging roller as a charger and a photoconductor as an image bearer. The photoconductor is disposed opposite the charging roller across a gap. A charging bias obtained by superimposing an AC voltage on a DC voltage is applied to the charging roller. The photoconductor is exposed based on image data, and an electrostatic latent image is formed on the photoconductor. The image forming apparatus further includes a high-voltage power supply to generate an output feedback voltage, a control unit as circuitry to control the high-voltage power supply based on the output feedback voltage and refer to first data to calculate the gap value corresponding to the voltage indicated by the output feedback voltage. The output feedback voltage indicates a voltage corresponding to an output current flowing from the charging roller to the photoconductor while the charging bias is applied to the charging roller. The first data indicates a relation between the voltage indicated by the output feedback voltage and a value indicating the size of the gap between the photoconductor and the charging roller.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view of an image forming apparatus according to embodiments of the present disclosure;

FIG. 2 is a schematic view illustrating a gap between a photoconductor and a charging roller included in a photoconductor unit illustrated in FIG. 1;

FIG. 3A is a schematic block diagram illustrating a hardware structure of the image forming apparatus according to embodiments of the present disclosure;

FIG. 3B is a functional block diagram of the image forming apparatus according to embodiments of the present disclosure;

FIG. 4 is a flowchart illustrating a gap calculation process performed by a control unit of the image forming apparatus according to a first embodiment;

FIG. 5 is a graph illustrating a relation between a gap value and an output feedback voltage;

FIG. 6 is a graph illustrating a relation between an elapsed time and the output feedback voltage;

FIG. 7 is a flowchart illustrating a gap calculation process performed by the control unit of the image forming apparatus according to a second embodiment;

FIG. 8 is a flowchart illustrating a gap calculation process performed by the control unit of the image forming apparatus according to a third embodiment;

FIG. 9 is a flowchart illustrating a gap calculation process performed by the control unit of the image forming apparatus according to a fourth embodiment;

FIG. 10 is a flowchart illustrating a gap calculation process performed by the control unit of the image forming apparatus according to a fifth embodiment;

FIG. 11 is a flowchart illustrating a gap calculation process performed by the control unit of the image forming apparatus according to a sixth embodiment;

FIG. 12 is a flowchart illustrating a gap calculation process performed by the control unit of the image forming apparatus according to a seventh embodiment;

FIG. 13 is a flowchart illustrating a gap calculation process performed by the control unit of the image forming apparatus according to an eighth embodiment;

FIG. 14 is a flowchart illustrating a gap calculation process performed by the control unit of the image forming apparatus according to a ninth embodiment; and

FIG. 15 is a flowchart illustrating a gap calculation process performed by the control unit of the image forming apparatus according to a tenth embodiment.

The accompanying drawings are intended to depict embodiments of the present disclosure and should not be interpreted to limit the scope thereof. The accompanying drawings are not to be considered as drawn to scale unless explicitly noted. In addition, identical or similar reference numerals designate identical or similar components throughout the several views.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

As used herein, the singular forms “a”, “an”, and “the” are intended to include the plural forms as well, unless the context clearly indicates otherwise.

Several embodiments of the present disclosure are described below with reference to the drawings.

However, elements, types, combinations of elements, shapes of the elements, and relative positions of components in the embodiments are examples and do not limit the scope of appended claims.

### Embodiment 1

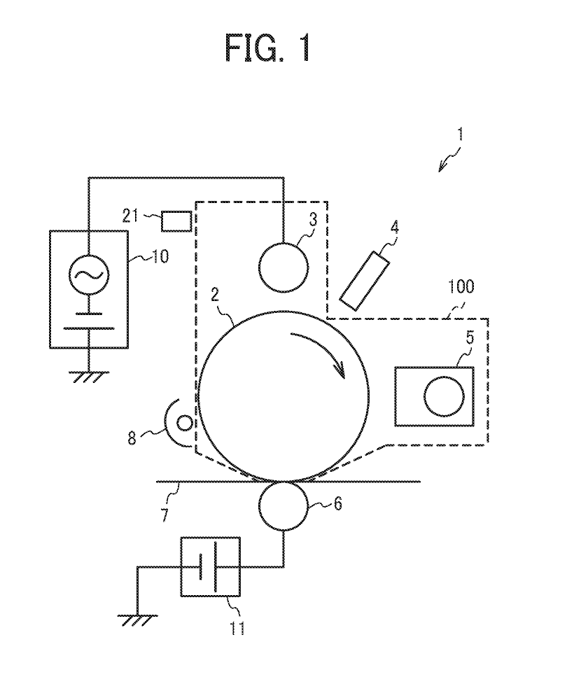

FIG. 1 is a schematic view of an image forming apparatus according to embodiments of the present disclosure.

An image forming apparatus 1 includes a high-voltage power supply 10 for charging, a high-voltage power source 11 for primary transfer, a photoconductor 2, a charging roller 3, an exposure device 4, a developing device 5, a primary transfer roller 6, an intermediate transfer belt 7, and a discharger 8 as components of a general indirect electrophotographic process. A photoconductor unit 100 includes the photoconductor 2, the charging roller 3, and the developing device 5.

An electrophotographic image forming operation performed by the image forming apparatus 1 is described below.

First, the high-voltage power supply 10 generates a charging bias obtained by superimposing an AC voltage on a DC voltage and applies the charging bias to the charging roller 3, thereby uniformly charging the photoconductor 2. Then, the exposure device 4 exposes the photoconductor 2 according to image signals, thereby forming an electrostatic latent image on the photoconductor 2.

The developing device 5 develops the electrostatic latent image on the photoconductor 2 into a toner image, and the high-voltage power source 11 applies a DC high voltage to the primary transfer roller 6, thereby transferring the toner image onto the intermediate transfer belt 7.

Then, the toner image on the intermediate transfer belt 7 is secondarily transferred onto a recording medium by a secondary transferor and fixed on the recording medium by a fixing device.

The discharger 8 removes electric charges remaining on the photoconductor 2, and the charging roller 3 charges the photoconductor 2 for next image forming process.

In the case of color printing, an image forming apparatus includes four photoconductor units 100, and the toner image on the photoconductor 2 for each color is transferred onto the intermediate transfer belt 7. Then, the toner images on the intermediate transfer belt 7 are secondarily transferred onto a recording medium by the secondary transferor and fixed on the recording medium by the fixing device, thereby forming a multicolor toner image.

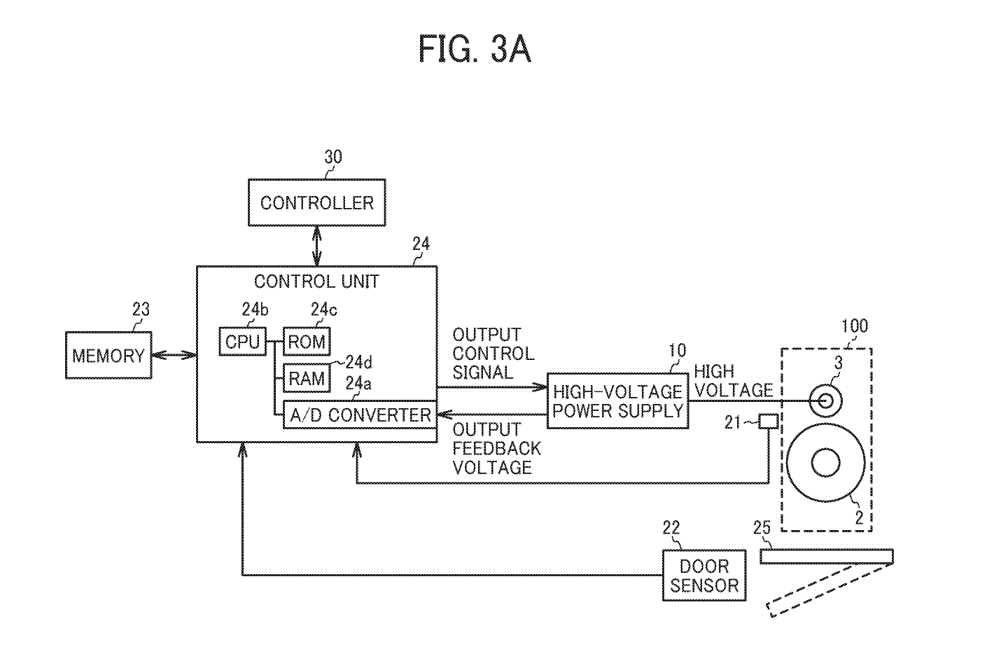

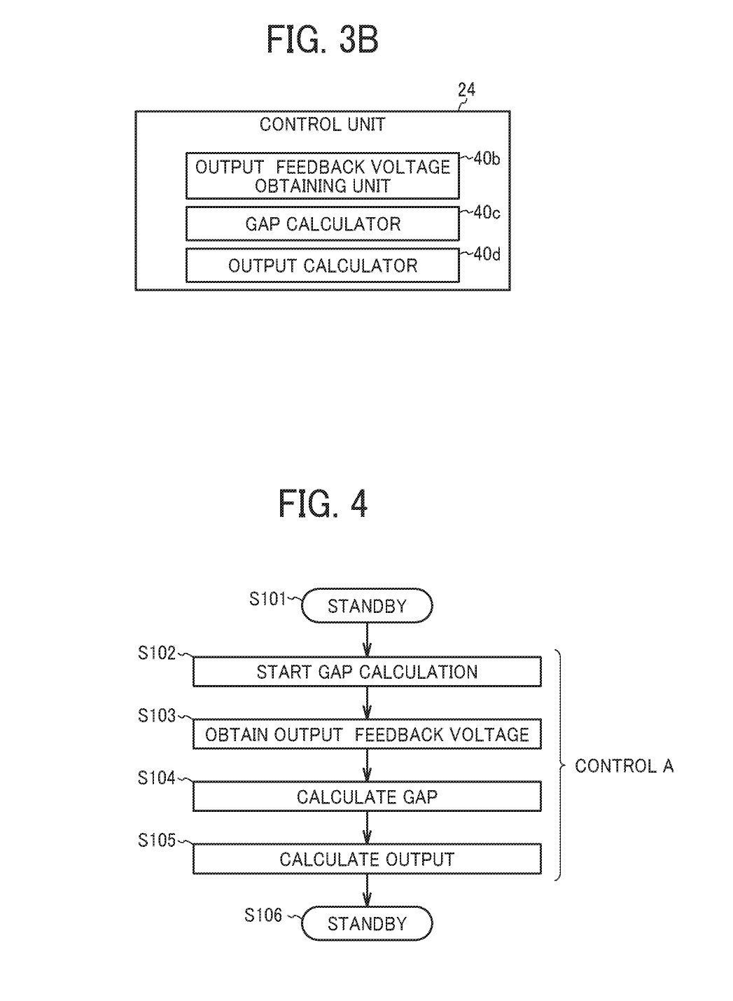

A temperature and humidity sensor 21 is disposed near the photoconductor unit 100, obtains temperature and humidity data, and outputs the data to a control unit 24 to be described with reference to FIG. 3.

The image forming apparatus 1 further includes a door 25 to remove the photoconductor unit 100 and install a new photoconductor unit 100.

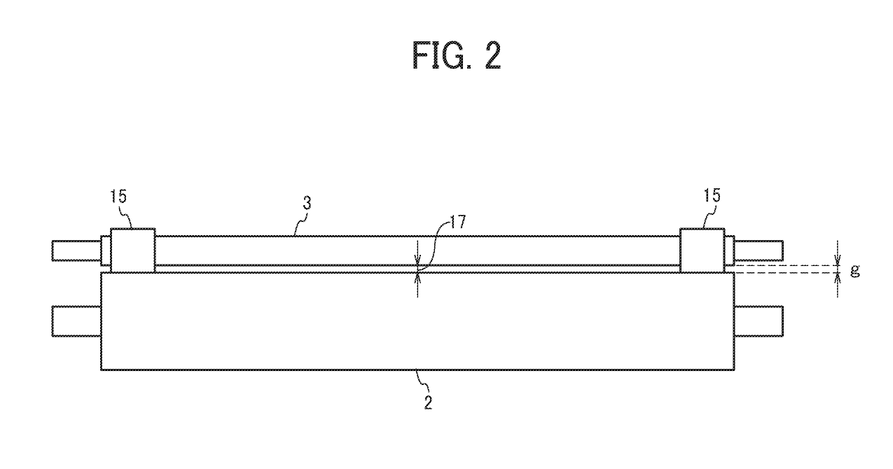

FIG. 2 is a schematic view illustrating a gap 17 between the photoconductor 2 and the charging roller 3 in the photoconductor unit 100 illustrated in FIG. 1.

As illustrated in FIG. 2, in non-contact charging, gap rollers 15 having a diameter greater than that of the charging roller 3 are disposed at both ends of the charging roller 3 in contact with the photoconductor 2 to maintain the gap 17 between the photoconductor 2 and the charging roller 3. That is, the photoconductor 2 faces the charging roller 3 across the gap 17.

FIG. 3A is a schematic block diagram illustrating a hardware structure of the image forming apparatus 1 according to the present embodiment.

The image forming apparatus 1 includes the high-voltage power supply 10, the temperature and humidity sensor 21, a door sensor 22, a memory 23, a control unit 24, and a controller 30.

The high-voltage power supply 10 generates a high voltage applied to the charging roller 3, which is obtained by superimposing the AC voltage on the DC voltage. The high-voltage power supply 10 generates an output feedback voltage (an output feedback signal) indicating a voltage corresponding to an output current flowing from the charging roller 3 as a charger to the photoconductor 2 while the charging bias is applied to the charging roller 3.

An output voltage of the high-voltage power supply 10 is determined based on a pulse width modulation (PWM) signal as an output control signal transmitted from the control unit 24. The AC voltage and the DC voltage are controlled by the respective output control signals. The high-voltage power supply 10 detects the output current and outputs the output feedback voltage, which is an analog signal, to the control unit 24.

The temperature and humidity sensor 21 disposed near the photoconductor unit 100 outputs temperature and humidity data to the control unit 24.

The door sensor 22 detects the opening and closing of the door 25 and outputs the opening and closing state to the control unit 24.

The memory 23 stores a gap value g calculated based on the output feedback voltage, the temperature and humidity data, and the like. The gap value g represents the size of the gap 17, that is, the distance between the photoconductor 2 and the charging roller 3.

The controller 30 controls the entire image forming apparatus 1 that is, for example, instructs print start and print end, and performs energy-saving control, management of various time, and the like.

The control unit 24 outputs the PWM signal as the output control signal to the high-voltage power supply 10.

The control unit 24 includes a central processing unit (CPU) 24b, a read only memory (ROM) 24c, a random access memory (RAM) 24d, and an analog to digital (AD) converter 24a.

The CPU 24b controls overall operations of the image forming apparatus 1 according to a program stored in the ROM 24c, using the RAM 24d as a working memory.

The ROM 24c is a read-only non-volatile storage medium that stores firmware and various data.

The RAM 24d is a volatile storage medium capable of high-speed reading and writing of information and is used as the working memory.

The AD converter 24a converts the output feedback voltage (an analog electric signal) input from the high-voltage power supply 10 into digital data and outputs the digital output feedback voltage data to the CPU 24b.

The output feedback voltage input to the AD converter 24a is a signal output from the high-voltage power supply 10. The high-voltage power supply 10 generates the output feedback voltage indicating the voltage corresponding to the output current flowing from the charging roller 3 to the photoconductor 2 while the charging bias is applied to the charging roller 3. The output current value and the output feedback voltage are related as follows:

output feedback voltage=0.833×output current value.

FIG. 3B is a functional block diagram of the image forming apparatus 1 according to the present embodiment.

The CPU 24b illustrated in FIG. 3A reads an operating system (OS) from the ROM 24c to the RAM 24d, and boots up the OS. Then, under the management of the OS, the CPU 24b reads a program (a processing module) of the application software from the ROM 24c and executes various processes, thereby implementing the control unit 24 illustrated in FIG. 3B.

The control unit 24 as circuitry calculates the gap value g based on the output feedback voltage output from the high-voltage power supply 10.

More specifically, the control unit 24 includes an output feedback voltage obtaining unit 40b, a gap calculator 40c, and an output calculator 40d as processing modules.

The output feedback voltage obtaining unit 40b obtains the output feedback voltage from the AD converter 24a.

The gap calculator 40c calculates the gap value g based on the output feedback voltage.

The output calculator 40d calculates the output current value based on the gap value g calculated by the gap calculator 40c and outputs the output control signal corresponding to the output current value.

FIG. 4 is a flowchart illustrating a gap calculation process performed by the control unit 24 according to the first embodiment.

In step S101, the control unit 24 is on standby.

In step S102, the control unit 24 starts calculating the gap value g. The control unit 24 outputs the output control signal to the high-voltage power supply 10, and the high-voltage power supply 10 applies the high voltage obtained by superimposing the AC voltage on the DC voltage to the charging roller 3.

The high-voltage power supply 10 outputs the output feedback voltage, which is an analog signal, to the AD converter 24a. The output feedback voltage is the voltage converted from the output current value. In step S103, the AD converter 24a of the control unit 24 converts the output feedback voltage from the analog signal to the digital data.

In step S104, the control unit 24 calculates the gap value g. That is, the control unit 24 refers to a table (for example, TABLE 1) illustrating the relation between the output feedback voltage and the gap value g stored in the memory 23 and calculates the gap value g.

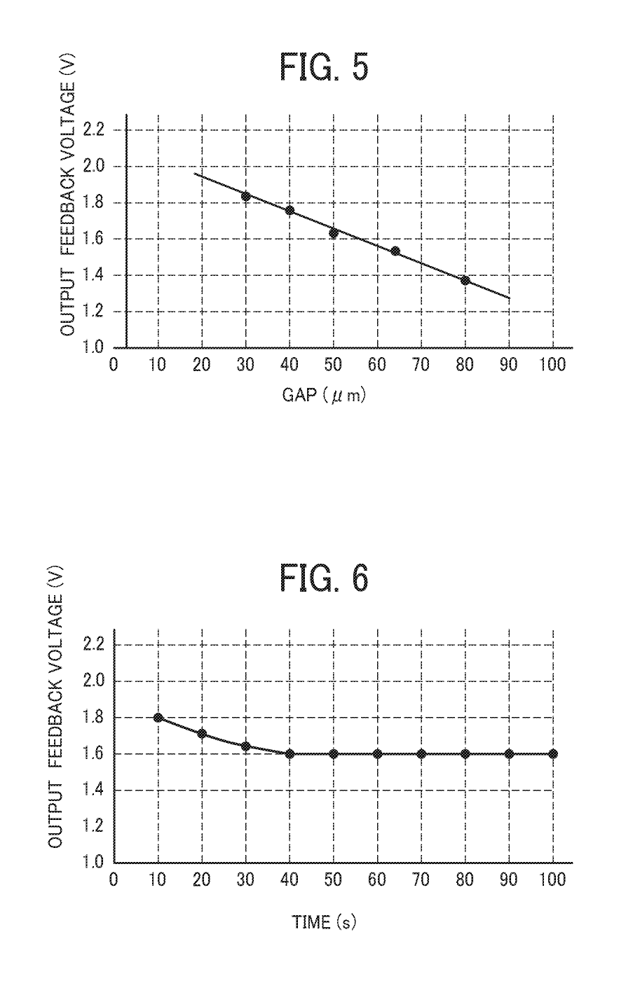

FIG. 5 is a graph illustrating the relation between the gap value g and the output feedback voltage. As illustrated in FIG. 5, a lower output feedback voltage corresponds to a larger gap value g. The relation between the gap value g and the output feedback voltage is expressed as a linear function.

TABLE 1 indicates the relation between the gap value g and the output feedback voltage obtained by referring to the graph illustrating the relation between the gap value g and the output feedback voltage, for example, illustrated in FIG. 5, which has been obtained by experiments in advance.

TABLE 1

| OUTPUT FEEDBACK VOLTAGE (V) | GAP VALUE (μm) |
|---|---|
| 1.83 | 30 |
| 1.78 | 40 |
| 1.63 | 50 |
| 1.57 | 60 |
| 1.48 | 70 |

In step S105, the output calculator 40d of the control unit 24 calculates the output current value based on the gap value g obtained in step S104.

That is, the control unit 24 refers to a table (for example, TABLE 2) illustrating a relation between the gap value g and the output current value stored in the memory 23 and determines the output current value. Note that, the data illustrating the relation between the gap value g and the output feedback voltage (e.g., first data) and the relation between the gap value g and the output current value (e.g., second data) can be stored in a storage device other than the memory 23.

TABLE 2 illustrates the relation between the gap value g and the output current value.

TABLE 2

| GAP VALUE (μm) | OUTPUT CURRENT (mA) |
|---|---|
| 30 | A |
| 40 | B |
| 50 | C |
| 60 | D |
| 70 | E |

The control unit 24 adjusts the output voltage so as to obtain a desired output current value. The output current value is set to a higher value as the gap value g increases. In the case of TABLE 2, the output current value becomes higher in the order of A, B, C, D, and E. The adjusted result of the output voltage is stored in the memory 23.

In step S106, the control unit 24 is on standby.

The control in steps S102 to S105 is referred to as a control A.

As described above, the control unit 24 refers to the first data indicating the relation between the voltage and the gap value g and calculates the gap value g corresponding to the output feedback voltage corresponding to the output current flowing from the charging roller 3 to the photoconductor 2. Therefore, the control unit 24 can calculate the gap value g between the photoconductor 2 and the charging roller 3 without increase of machine size.

### Embodiment 2

Next, a description is given of the image forming apparatus 1 according to a second embodiment. FIG. 6 is a graph illustrating an example of a relation between an elapsed time from charging start and the output feedback voltage.

In the example illustrated in FIG. 6, the output feedback voltage decreases until the elapsed time of approximately 40 seconds from charging start and then becomes stable. That is, the gap value g is not stable in an initial stage of operation. This is because contact pressure of a member contacting the photoconductor 2, such as a cleaning blade, is unstable in the initial stage of operation. The graph illustrated in FIG. 6 can be expressed as a quadratic or higher function (e.g., cubic or quartic function).

As described in the first embodiment, in a case in which the gap value g is calculated based on the output feedback voltage, if the output feedback voltage is obtained after waiting time of 40 seconds until a stable period, a decision time of the gap value g becomes longer, thus forcing users to wait. Further, if the output feedback voltage obtained during a period in which the gap value g is unstable in the initial stage is used, the control unit 24 determines the gap value g to be narrower than that in the stable period, thereby setting a smaller output current value.

In this case, in the stable period, the control unit 24 undesirably controls charging with the smaller output current value than a target current value, causing abnormal images such as defective images with white spots.

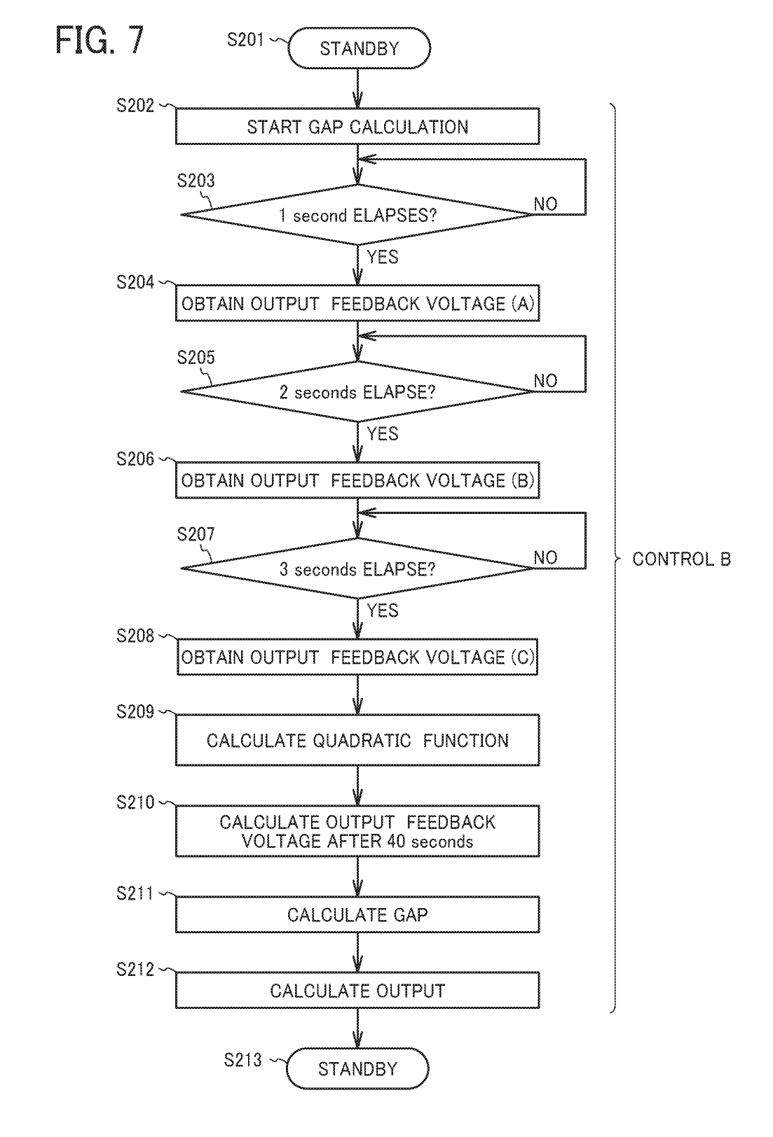

A description is provided of a control operation according to the second embodiment with reference to a flowchart illustrated in FIG. 7. In FIG. 7, a target is, but not limited to, a quadratic function graph. The operation in the case of the quadratic or higher function (e.g., cubic or quartic function) can be similar to that illustrated in FIG. 7.

FIG. 7 is the flowchart illustrating a gap calculation process performed by the control unit 24 of the image forming apparatus 1 according to the second embodiment.

In step S201, the control unit 24 is on standby.

In step S202, the control unit 24 starts calculating the gap value g. The control unit 24 outputs the output control signal to the high-voltage power supply 10, and the high-voltage power supply 10 applies the high voltage obtained by superimposing the AC voltage on the DC voltage to the charging roller 3.

In step S203, the control unit 24 determines whether the elapsed time from charging start has reached 1 second as a first decision.

Note that, 1 second from charging start is one example, the time can be set so as not to keep users waiting.

In step S204, the control unit 24 obtains the output feedback voltage (A) after 1 second from charging start.

In step S205, the control unit 24 determines whether the elapsed time from charging start has reached 2 seconds as a second decision.

Note that, 2 seconds from charging start is one example, the time can be set so as not to keep users waiting.

In step S206, the control unit 24 obtains the output feedback voltage (B) after 2 seconds from charging start.

In step S207, the control unit 24 determines whether the elapsed time from charging start has reached 3 seconds as a third decision.

Note that, 3 seconds from charging start is one example, the time can be set so as not to keep users waiting.

In step S208, the control unit 24 obtains the output feedback voltage (C) after 3 seconds from charging start.

In step S209, the control unit 24 calculates the quadratic function based on the output feedback voltages (A), (B), and (C) after 1, 2, and 3 seconds from charging start, respectively, obtained in steps S204, S206, and S208.

In step S210, the control unit 24 calculates the output feedback voltage in the stable period, for example, after 40 seconds from charging start by the quadratic function calculated in step S210.

In step S211, the control unit 24 refers to the table (for example, TABLE 1) illustrating the relation between the output feedback voltage and the gap value g stored in the memory 23 and calculates the gap value g. TABLE 1 is obtained by referring to the graph illustrating the relation between the gap value g and the output feedback voltage, for example, illustrated in FIG. 5, which has been obtained by experiments in advance.

In step S212, the control unit 24 calculates the desired output current value based on the gap value g. The control unit 24 refers to the table (for example, TABLE 2) illustrating the relation between the gap value g and the output current value stored in the memory 23, thereby determining the desired output current value. The control unit 24 adjusts the output voltage so as to obtain the desired output current value. The output current value is set to the higher value as the gap value g increases. In the case of TABLE 2, the output current value becomes higher in the order of A, B, C, D, and E. The adjusted result of the output voltage is stored in the memory 23.

In step S213, the control unit 24 is on standby.

According to the gap calculation process described above with reference to the flowchart, the control unit 24 can calculate the gap value g based on the output feedback voltage in a short period that does not make users wait and can be set an optimum voltage not to cause defective images.

The control in steps S202 to S212 is referred to as a control B.

Accordingly, the optimum voltage can be applied to the photoconductor 2, thereby minimizing defective images that occurs in comparative image forming apparatuses, such as images with white spots or black dots.

### Embodiment 3

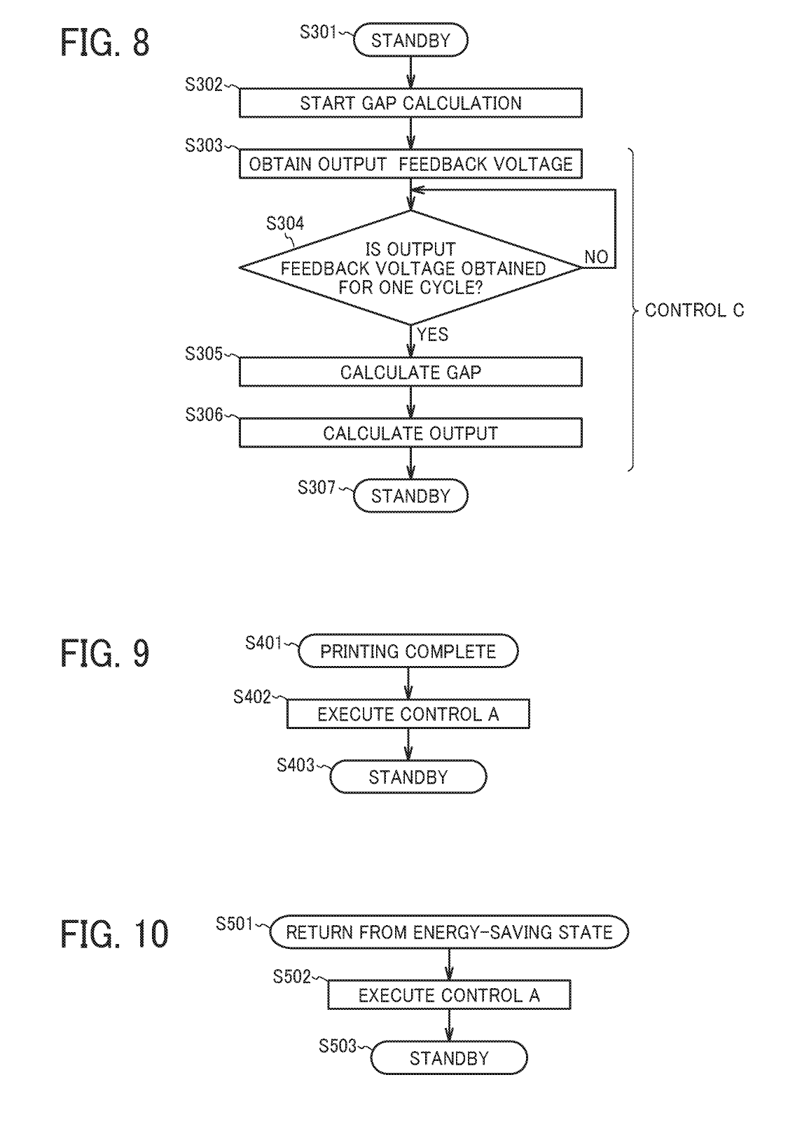

Next, a description is given of the image forming apparatus 1 according to a third embodiment. FIG. 8 is a flowchart illustrating a gap calculation process performed by the control unit 24 according to the third embodiment.

In step S301, the control unit 24 is on standby.

In step S302, the control unit 24 starts calculating the gap value g. At that time, as the image forming apparatus 1 starts operation, the photoconductor 2 and the charging roller 3 start to rotate. The control unit 24 outputs the output control signal to the high-voltage power supply 10, and the high-voltage power supply 10 applies the high voltage obtained by superimposing the AC voltage on the DC voltage to the charging roller 3.

In step S303, the control unit 24 obtains the output feedback voltage. The control unit 24 obtains the output feedback voltage, which is the analog signal converted from the output current value, output from the high-voltage power supply 10 at intervals oft second (for example, 0.5 second).

In step S304, the control unit 24 determines whether the output feedback voltage has been obtained for one cycle of the photoconductor 2, that is, the control unit 24 determines whether the time corresponding to one cycle of the photoconductor 2 has elapsed.

In step S305, the control unit 24 calculates the gap value g. That is, the control unit 24 averages the output feedback voltage obtained in step S303, refers to the table (for example, TABLE 1) illustrating the relation between the output feedback voltage and the gap value g stored in the memory 23, and calculates the gap value g corresponding to the output feedback voltage. TABLE 1 is obtained by referring to the graph illustrating the relation between the gap value g and the output feedback voltage, for example, illustrated in FIG. 5, which has been obtained by experiments in advance.

In step S306, the control unit 24 calculates the output voltage. Here, the control unit 24 calculates the desired output current value based on the gap value g calculated in step S305. That is, the control unit 24 refers to the table (for example, TABLE 2) illustrating the relation between the gap value g and the output current value stored in the memory 23, thereby determining the desired output current value. The control unit 24 adjusts the output voltage so as to obtain the desired output current value. The output current value is set to the higher value as the gap value g increases. In the case of TABLE 2, the output current value becomes higher in the order of A, B, C, D, and E. The adjusted result of the output voltage is stored in the memory 23.

In step S307, the control unit 24 is on standby.

With this control, the gap value g is accurately calculated.

In the third embodiment, the control unit 24 obtains the output feedback voltage for one cycle of the photoconductor 2. Alternatively, the control unit 24 obtains and averages the output feedback voltage for one or more cycles of the photoconductor 2.

The control in steps S302 to S306 is referred to as a control C.

### Embodiment 4

Next, a description is given of the image forming apparatus 1 according to a fourth embodiment. FIG. 9 is a flowchart illustrating a gap calculation process performed by the control unit 24 according to the fourth embodiment.

In step S401, the control unit 24 finishes printing operation.

In step S402, the control unit 24 executes the control A described in the first embodiment.

In step S403, the control unit 24 is on standby.

As described above, since the control unit 24 calculates the gap value g after printing, thereby reducing waiting time before printing.

### Embodiment 5

Next, a description is given of the image forming apparatus 1 according to a fifth embodiment. FIG. 10 is a flowchart illustrating a gap calculation process performed by control unit 24 according to the fifth embodiment.

In step S501, the control unit 24 accepts a signal for returning from an energy-saving state from the controller 30.

In step S502, the control unit 24 executes the control A described in the first embodiment.

In step S503, the control unit 24 is on standby.

As described above, since the control unit 24 calculates the gap value g when the image forming apparatus 1 returns from the energy-saving state, the control unit 24 can correct changes of the gap value g in the energy-saving state.

### Embodiment 6

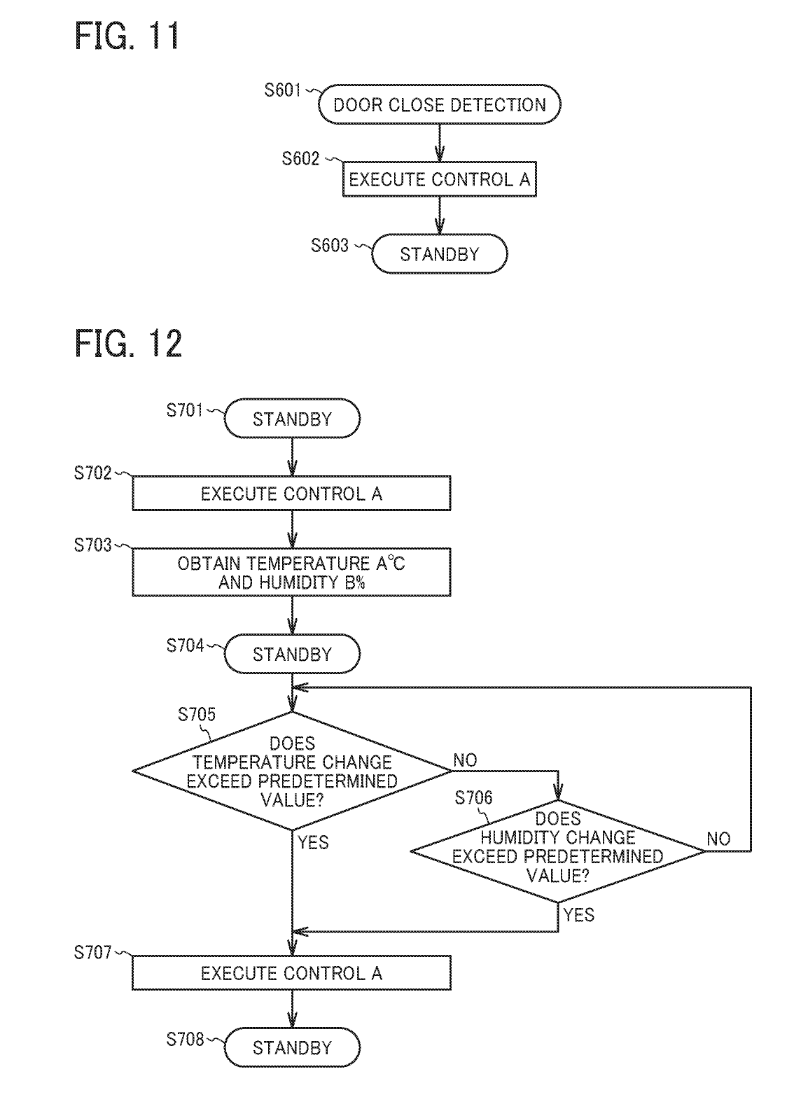

Next, a description is given of the image forming apparatus 1 according to a sixth embodiment. FIG. 11 is a flowchart illustrating a gap calculation process performed by the control unit 24 according to the sixth embodiment.

In step S601, the door sensor 22 to detect the opening and closing of the door 25 of the image forming apparatus 1 detects that the door 25 is closed.

In step S602, the control unit 24 executes the control A described in the first embodiment.

In step S603, the control unit 24 is on standby.

As described above, since the control unit 24 calculates the gap value g when the door 25 is closed, the control unit 24 can correct changes of the gap value g while the door 25 opens.

### Embodiment 7

Next, a description is given of the image forming apparatus 1 according to a seventh embodiment. FIG. 12 is a flowchart illustrating a gap calculation process performed by the control unit 24 according to the seventh embodiment.

In step S701, the control unit 24 is on standby.

In step S702, the control unit 24 executes the control A described in the first embodiment.

In step 703, the control unit 24 obtains temperature of A and humidity of B % detected by the temperature and humidity sensor 21 and stores the temperature and humidity data in the memory 23.

In step S704, the control unit 24 is on standby.

In step S705, the control unit 24 determines whether the temperature ADC obtained from the memory 23 changes by a predetermined value or greater.

In a case in which the temperature ADC changes by the predetermined value or greater, the control unit 24 executes the control A described in the first embodiment in step S707. Then, process goes to step S708. In step S708, the control unit 24 is on standby.

In a case in which the temperature ADC does not change by the predetermined value or greater, the process goes to step S706, and the control unit 24 determines whether the humidity B % obtained from the memory 23 changes by a predetermined value or greater.

In step S706, in a case in which the humidity B % does not change by a predetermined value or greater, process returns to step S705 and is repeated.

On the other hand, in a case in which the humidity B % changes by the predetermined value or greater, the control unit 24 executes the control A described in the first embodiment in step S707. Then, process goes to step S708. In step S708, the control unit 24 is on standby.

Users can arbitrarily set the predetermined values of the temperature and humidity.

Note that, the control unit 24 can execute the control B described in the second embodiment or the control C described in the third embodiment instead of the control A in step S707.

As described above, since the control unit 24 calculates the gap value g when temperature or humidity changes, the control unit 24 can correct changes of the gap value g due to temperature or humidity fluctuation.

### Embodiment 8

Next, a description is given of the image forming apparatus 1 according to an eighth embodiment. FIG. 13 is a flowchart illustrating a gap calculation process performed by the control unit 24 according to the eighth embodiment.

In step S801, the control unit 24 is on standby.

In step S802, the control unit 24 executes the control A described in the first embodiment. Alternatively, the control unit 24 can execute the control B described in the second embodiment or the control C described in the third embodiment instead of the control A.

In step S803, the control unit 24 obtains the current time t1 from the controller 30 and stores the current time t1 in the memory 23.

In step S804, the control unit 24 obtains the current time t2 from the controller 30 and stores the current time t2 in the memory 23.

In step S805, the control unit 24 calculates an elapsed time (i.e., Δt=t2−t1) from execution of the control A based on the current times t1 and t2 read from the memory 23 and determines whether the elapsed time Δt exceeds a predetermined time.

In a case in which the elapsed time Δt exceeds the predetermined time, process goes to step S806, and the control unit 24 executes the control A described in the first embodiment.

In step S807, the control unit 24 is on standby.

As described above, since the control unit 24 calculates the gap value g when the elapsed time Δt exceeds the predetermined time, the control unit 24 can correct changes of the gap value g over time. Users can arbitrarily set the predetermined time.

### Embodiment 9

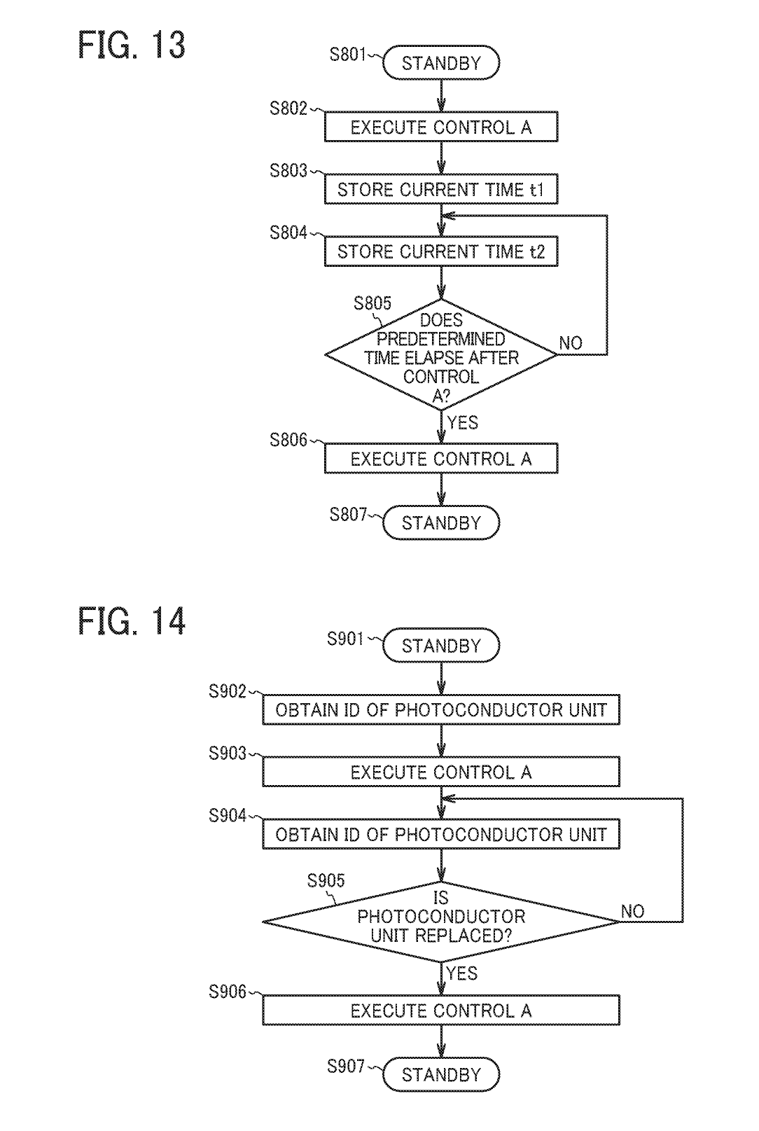

Next, a description is given of the image forming apparatus 1 according to a ninth embodiment. FIG. 14 is a flowchart illustrating a gap calculation process performed by the control unit 24 according to the ninth embodiment.

In step S901, the control unit 24 is on standby.

In step S902, the control unit 24 obtains a unit identification (ID) of the photoconductor unit 100 from a unit memory attached to the photoconductor unit 100 and stores the unit ID in the memory 23.

In step S903, the control unit 24 executes the control A described in the first embodiment.

In step S904, the control unit 24 obtains the unit identification (ID) of the unit from the unit memory attached to the photoconductor unit 100.

In step S905, the control unit 24 determines whether the photoconductor unit 100 has been replaced. That is, the control unit 24 determines whether the obtained unit ID in step S904 matches the unit ID read from the memory 23. In a case in which the both unit IDs do not match each other, since the photoconductor unit 100 has been replaced, the process goes to step S906.

In step S906, the control unit 24 executes the control A described in the first embodiment.

In step S907, the control unit 24 is on standby.

As described above, since the control unit 24 detects replacement of the photoconductor unit 100 after execution of the control A, the control unit 24 can correct changes of the gap value g due to the replacement of the photoconductor unit 100.

### Embodiment 10

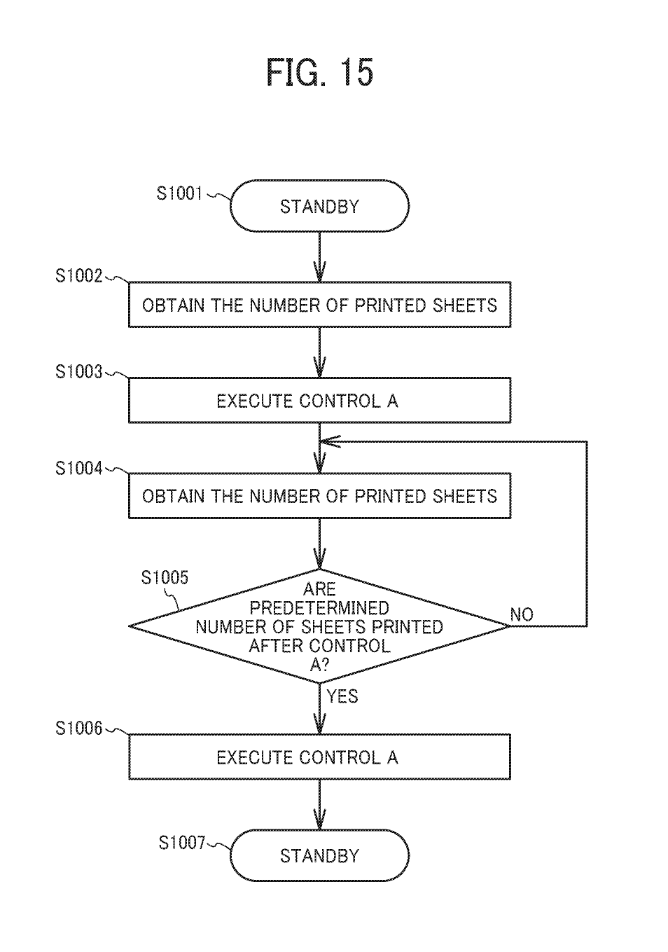

Next, a description is given of the image forming apparatus 1 according to a tenth embodiment. FIG. 15 is a flowchart illustrating a gap calculation process performed by the control unit 24 according to the tenth embodiment.

In step S1001, the control unit 24 is on standby.

In step S1002, the control unit 24 obtains the number of printed sheets D1 of the unit from the unit memory attached to the photoconductor unit 100 and stores the number of printed sheets D1 in the memory 23.

In step S1003, the control unit 24 executes the control A described in the first embodiment.

In step S1004, the control unit 24 obtains the number of printed sheets D2 of the unit from the unit memory attached to the photoconductor unit 100 and stores the number of printed sheets D2 in the memory 23.

In step S1005, the control unit 24 calculates the number of printed sheets (i.e., ΔD=D2−D1) from execution of the control A based on the numbers of printed sheets D1 and D2 read from the memory 23 and determines whether the number of printed sheets ΔD exceeds a predetermined number. In a case in which the number of printed sheets ΔD does not exceed the predetermined number, process returns to step S1004 and is repeated.

In a case in which the number of printed sheets ΔD is more than or equal to the predetermined number, the control unit 24 executes the control A described in the first embodiment in step S1006.

In step S1007, the control unit 24 is on standby.

As described above, since the control unit 24 calculates the gap value g when the number of printed sheets ΔD from execution of the control A exceeds the predetermined number, the control unit 24 can correct changes of the gap value g due to printing. Users can arbitrarily set the predetermined number.

Variations

In the descriptions above, in step S402 according to the fourth embodiment, step S502 according to the fifth embodiment, step S602 according to the sixth embodiment, step S702 according to the seventh embodiment, step S806 according to the eighth embodiment, step S903 according to the ninth embodiment, and steps S1003 and S1006 according to the tenth embodiment, the control unit 24 executes the control A.

Alternatively, the control unit 24 can execute the control B described in the second embodiment or the control C described in the third embodiment instead of the control A in these steps.

Aspect 1

An image forming apparatus 1 according to Aspect 1 includes at least one photoconductor unit 100 including a charging roller 3 as a charger and a photoconductor 2 as an image bearer. A charging bias obtained by superimposing an alternating current (AC) voltage on a direct current (DC) voltage is applied to the charging roller 3. The photoconductor 2 is disposed opposite the charging roller 3 across a gap 17. The photoconductor 2 is exposed based on image data, and an electrostatic latent image is formed on the photoconductor 2. The image forming apparatus 1 further includes a high-voltage power supply 10 to generate an output feedback voltage, a control unit 24 as circuitry to control the high-voltage power supply 10 based on the output feedback voltage and refer to first data to calculate a gap value g corresponding to a voltage indicated by the output feedback voltage. The output feedback voltage indicates the voltage corresponding to an output current flowing from the charging roller 3 to the photoconductor 2 while the charging bias is applied to the charging roller 3. The first data indicates a relation between the voltage indicated by the output feedback voltage and the gap value g indicating a size of the gap 17.

According to Aspect 1, the control unit 24 as the circuitry refers to the first data indicating the relation between the voltage and the gap value g, which indicates the size of the gap 17, and calculates the gap value g corresponding to the output feedback voltage corresponding to the output current flowing from the charging roller 3 to the photoconductor 2. Therefore, the control unit 24 can calculate the gap value g between the photoconductor 2 and the charging roller 3 without increase of machine size.

With such a configuration and operation, the control unit 24 can calculate the gap value g between the photoconductor 2 and the charging roller 3 without an optical sensor used in comparative technologies.

Aspect 2

In the image forming apparatus 1 according to Aspect 2, the control unit 24 refers to second data indicating a relation between the gap value g and the output current value, calculates the output current value corresponding to the gap value g calculated, and controls the AC voltage output from the high-voltage power supply 10 to adjust the output current to the output current value corresponding to the gap value g.

Accordingly, the optimum voltage can be applied to the photoconductor 2, thereby minimizing defective images that occurs in comparative image forming apparatuses, such as images with white spots or black dots.

Aspect 3

In the image forming apparatus 1 according to Aspect 3, the control unit 24 obtains voltages indicated by output feedback voltages at a plurality of times (three or more) and estimate the voltage after the plurality of times.

Accordingly, the control unit 24 can estimate the gap value g based on the output feedback voltage in a short period without forcing users to wait, and the appropriate current value can be set.

Aspect 4 In the image forming apparatus 1 according to Aspect 4, the control unit 24 obtains the voltage indicated by the output feedback voltage for one cycle or more of the photoconductor 2 and averages the obtained voltage to calculate the gap value g.

Accordingly, the control unit 24 can calculate accurately the gap value g.

Aspect 5

In the image forming apparatus 1 according to Aspect 5, the control unit 24 calculates the gap value g when printing is finished.

Accordingly, the control unit 24 can avoid calculating the gap value g before printing, thereby reducing waiting time.

Aspect 6

In the image forming apparatus 1 according to Aspect 6, the control unit 24 calculates the gap value g when the image forming apparatus 1 returns from the energy-saving state.

Accordingly, the control unit 24 can correct fluctuation of the gap value g occurring in the energy-saving state.

Aspect 7

The image forming apparatus 1 according to Aspect 7 further includes a door 25 to install and remove the photoconductor unit 100 in and from the image forming apparatus 1 and a door sensor 22 to detect opening and closing state of the door 25, and the control unit 24 calculates the gap value g when the door sensor 22 detects that the door 25 is closed.

Accordingly, the control unit 24 can correct fluctuation of the gap value g occurring while the door 25 is open.

Aspect 8

The image forming apparatus 1 according to Aspect 8 further includes a temperature and humidity sensor 21. The control unit 24 calculates the gap value g when the temperature or humidity gauged by the temperature and humidity sensor 21 changes by a predetermined value or greater.

Accordingly, the control unit 24 can correct fluctuation of the gap value g due to fluctuation of the temperature and humidity.

Aspect 9

In the image forming apparatus 1 according to Aspect 9, the control unit 24 calculates the gap value g when a predetermined time from the calculation of the gap value g has elapsed.

Accordingly, the control unit 24 can correct fluctuations of the gap value g over time.

Aspect 10

In the image forming apparatus 1 according to Aspect 5, the control unit 24 calculates the gap value g when the photoconductor unit 100 is replaced.

Accordingly, the control unit 24 can correct fluctuations of the gap value g due to replacement of the photoconductor unit 100.

Aspect 11

In the image forming apparatus 1 according to Aspect 11, the control unit 24 calculates the gap value g when the number of printed sheets from the calculation of the gap value g has reached a predetermined number.

Accordingly, the control unit 24 can correct fluctuation of the gap value g due to printing.

Aspect 12.

An image forming method according to Aspect 12 includes generating a charging bias obtained by superimposing an alternating current (AC) voltage on a direct current (DC) voltage, applying the charging bias to a charging roller 3, forming an electrostatic latent image on the photoconductor 2 by exposure based on image data, generating an output feedback voltage indicating a voltage corresponding to an output current flowing from the charging roller 3 to the photoconductor 2 while the charging bias is applied to the charging roller 3, controlling the high-voltage power supply 10 for charging based on the output feedback voltage generated by the high-voltage power supply 10 for charging, and referring to first data indicating a relation between the voltage indicated by the output feedback voltage and a gap value g indicating a size of the gap 17, to calculate the gap value g corresponding to the voltage indicated by the output feedback voltage (i.e., step S104).

The operation and effect according to Aspect 12 are the same or substantially the same as those of the Aspect 1. Therefore, redundant description is omitted.

Aspect 13

A non-transitory recording medium storing a program which, when executed by one or more processors, cause the one or more processors to perform a method included generating a charging bias obtained by superimposing an alternating current (AC) voltage on a direct current (DC) voltage, applying the charging bias to a charging roller 3, forming an electrostatic latent image on the photoconductor 2 by exposure based on image data, generating an output feedback voltage indicating a voltage corresponding to an output current flowing from the charging roller 3 to the photoconductor 2 while the charging bias is applied to the charging roller 3, controlling the high-voltage power supply 10 for charging based on the output feedback voltage generated by the high-voltage power supply 10 for charging, and referring to first data indicating a relation between the voltage indicated by the output feedback voltage and a gap value g indicating a size of the gap 17, to calculate the gap value g corresponding to the voltage indicated by the output feedback voltage.

Therefore, the processor can perform the method.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. An image forming apparatus comprising:
at least one photoconductor unit to form an electrostatic latent image on a photoconductor by exposure based on image data,
the at least one photoconductor unit including:
a charger to which a charging bias obtained by superimposing an alternating current (AC) voltage on a direct current (DC) voltage is applied; and
the photoconductor disposed opposite the charger across a gap;
a high-voltage power supply for charging to generate an output feedback voltage indicating a voltage corresponding to an output current flowing from the charger to the photoconductor while the charging bias is applied to the charger; and
circuitry to control the high-voltage power supply for charging based on the output feedback voltage generated by the high-voltage power supply for charging, and refer to first data indicating a relation between the voltage indicated by the output feedback voltage and a gap value indicating a size of the gap, to calculate the gap value corresponding to the voltage indicated by the output feedback voltage.

2. The image forming apparatus according to claim 1,
wherein the circuitry refers to second data indicating a relation between the gap value and an output current value and calculates the output current value corresponding to the gap value calculated, to control the AC voltage to adjust the output current to the output current value corresponding to the gap value.

3. The image forming apparatus according to claim 1,
wherein the circuitry obtains voltages indicated by output feedback voltages at a plurality of times and estimates the voltage after the plurality of times.

4. The image forming apparatus according to claim 1,
wherein the circuitry obtains the voltage indicated by the output feedback voltage during one or more cycles of the photoconductor and averages the voltage obtained during the one or more cycles to calculate the gap value.

5. The image forming apparatus according to claim 1,
wherein the circuitry calculates the gap value when printing is finished.

6. The image forming apparatus according to claim 1,
wherein the circuitry calculates the gap value when the image forming apparatus returns from an energy-saving state.

7. The image forming apparatus according to claim 1 further comprising:
a door to install and remove the photoconductor unit in and from the image forming apparatus; and
a door sensor to detect opening and closing of the door,
wherein the circuitry calculates the gap value when the door sensor detects that the door is closed.

8. The image forming apparatus according to claim 1 further comprising a temperature and humidity sensor to detect temperature and humidity,
wherein the circuitry calculates the gap value when the temperature or humidity detected by the temperature and humidity sensor changes by a predetermined value or greater.

9. The image forming apparatus according to claim 1,
wherein the circuitry calculates the gap value when a predetermined time from a calculation of the gap value has elapsed.

10. The image forming apparatus according to claim 1,
wherein the circuitry calculates the gap value when the photoconductor unit has been replaced.

11. The image forming apparatus according to claim 1,
wherein the circuitry calculates the gap value when the number of printed sheets from a calculation of the gap value has reached a predetermined number.

12. An image forming method comprising:
generating a charging bias obtained by superimposing an alternating current (AC) voltage on a direct current (DC) voltage;
applying the charging bias to a charger;
forming a static latent image on a photoconductor by exposure based on image data;
generating an output feedback voltage indicating a voltage corresponding to an output current flowing from the charger to the photoconductor while the charging bias is applied to the charger;
controlling a high-voltage power supply for charging based on the output feedback voltage generated by the high-voltage power supply for charging; and
referring to first data indicating a relation between the voltage indicated by the output feedback voltage and a gap value indicating a size of a gap, to calculate the gap value corresponding to the voltage indicated by the output feedback voltage.

13. A non-transitory recording medium storing a program which, when executed by one or more processors, cause the one or more processors to perform an image forming method comprising:
generating a charging bias obtained by superimposing an alternating current (AC) voltage on a direct current (DC) voltage;
applying the charging bias to a charger;
forming a static latent image on a photoconductor by exposure based on image data;
generating an output feedback voltage indicating a voltage corresponding to an output current flowing from the charger to the photoconductor while the charging bias is applied to the charger;
controlling a high-voltage power supply for charging based on the output feedback voltage generated by the high-voltage power supply for charging; and
referring to first data indicating a relation between the voltage indicated by the output feedback voltage and a gap value indicating a size of a gap, to calculate the gap value corresponding to the voltage indicated by the output feedback voltage.
